(19) United States
(12) Patent Application Publication
(10) Pub. No.: US 2008/0018592 A1
(43) Pub. Date: Jan. 24, 2008

(54) Apparatus and method for haptic support in portable terminal

(75) Inventor: Jung-Sik Park, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/729,475

(22) Filed: Mar. 29, 2007

(30) Foreign Application Priority Data
May 9, 2006 (KR) 2006-0041401

(51) Int. Cl. G09G 5/00

(52) U.S. Cl. 345/156

(57) ABSTRACT

Provided are an apparatus and method for haptic support in a portable terminal. A haptic emitter provides an indication of a position change according to a manipulation of a button by a user, and receives control data and emits vibration or emits a reactivity opposite a predetermined direction. A position inputter provides data including the position change. A controller receives the data including the position change from the position inputter, and provides a control signal according to settings of a pre-run program. A driver receives the control signal from the controller, and drives the haptic emitter. A permanent magnet and electromagnets are used to create magnetic fields that provide reactivity, so that when a user manipulates and changes the position of the button, the reactivity that opposes the change in position or vibration can be provided while consuming minimal power and taking up minimal installation space, to provide an efficient apparatus.

### PRIORITY

This application claims priority under 35 U.S.C. § 119 to an application entitled “Apparatus and Method for Haptic Support in Portable Terminal” filed in the Korean Intellectual Property Office on May 9, 2006 and allocated Serial No. 2006-41401, the contents of which are incorporated herein by reference.

### BACKGROUND OF THE INVENTION

1. Field of the Invention

The present invention relates generally to haptic support, and more particularly, to an apparatus and method for haptic support in a portable terminal that can transmit at least the sense of touch from the five senses through the use of reactivity imparted from permanent magnets and electromagnets built into the device below a button when a user presses the button.

2. Description of the Related Art

The traditional method of inputting commands and other data in portable terminals is done using keypads. In some modern portable terminals, inputting data can be performed by directly contacting a touch screen that has a built-in touch sensitive device, or through a user's voice commands to perform certain predetermined operations.

However, despite the intuitive nature of touch screens, equipping portable terminals with touch screens necessitates their having a slide or bar configuration. As such, because the screens are always outwardly exposed, and touch screens (unlike keypads) do not require a predetermined amount of pressure to be activated, contact with external objects can easily lead to unintended commands input to touch screens. Of course, a pause function to prevent unintended inputs from being entered into touch screens exists. However, having to purposely enable this function may cause a user inconvenience. When considering the voice input method, its technology is still not advanced enough to enable it to satisfactorily replace current inputting methods.

Therefore, despite the existence of other inputting methods, the keypad is still the most widely used method.

A modern keypad not only has buttons for inputting numbers and characters, etc., but also has a navigation key that works on the principle of a joystick, enabling games and other functions to be run on the portable terminal. When a joystick-type navigation key is used for gaming, etc., a built-in vibration motor can be used to supplement the sense of touch.

FIGS. 1A and 1B show perspective views of haptic support apparatuses used in portable terminals, according to the related art.

FIG. 1A shows a haptic support apparatus according to the related art, including an input button 101 that contact input sensors 105 and 106 which sense when they are pressed. If required, vibration is provided by an actuator 110 and transmitted to the input button 101 through a lever arm 115.

The actuator 110 shown providing vibration is a piezo-electric actuator. However, a motor, moving magnet, or any one of many other actuator types can be used to provide vibration. When applied to a joystick-type navigation button, however, these actuators can only transmit vibration and not resistance (hereinafter called reactivity) against pressure applied to the button.

FIG. 1B shows two motors 125 and 120 along x and y axes providing both vibration and reactivity. However, the use of two motors consumes much power and requires a large installation space.

To date, haptic technology applicable to portable terminals consists simply of transmitting vibration to a user when a fixed button attached to a vibration motor is pressed in a certain mode. There is no available technology capable of efficiently providing a button that moves 360° with reactivity while consuming a small installation space for the device.

### SUMMARY OF THE INVENTION

An object of the present invention is to substantially solve at least the above problems and/or disadvantages and to provide at least the advantages below. Accordingly, an object of the present invention is to provide an apparatus and method capable of not only providing visual feedback to button inputs, but also an assortment of tactile responses in a portable terminal.

Another object of the present invention is to provide an apparatus and method capable of providing tactile responses while occupying a small installation space.

According to a first aspect of the present invention, there is provided an apparatus for haptic support in a portable terminal, including a haptic emitter for providing a position change according to a manipulation of a button by a user, and receiving control data and emitting vibration or emitting a reactivity opposite a predetermined direction; a position inputter for providing data including the position change; a controller for receiving the data including the position change from the position inputter, and providing a control signal according to settings of a pre-run program; and a driver for receiving the control signal from the controller, and driving the haptic emitter.

According to a second aspect of the present invention, there is provided an apparatus for haptic emitting in a portable terminal, including a permanent magnet connected to and enveloping a button manipulated by a user and disposed within a case of the portable terminal; and at least one electromagnet disposed around the permanent magnet.

According to a third aspect of the present invention, there is provided a method for haptic support in a portable terminal, including providing data including position change data according to a manipulation of a button by a user; using the provided data for determining a type of haptic emission to emit; providing a control signal for emitting the type of haptic emission determined to be emitted; and emitting the type of haptic emission determined to be emitted through the control signal.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B show perspective views of haptic support apparatuses used in portable terminals, according to the related art;

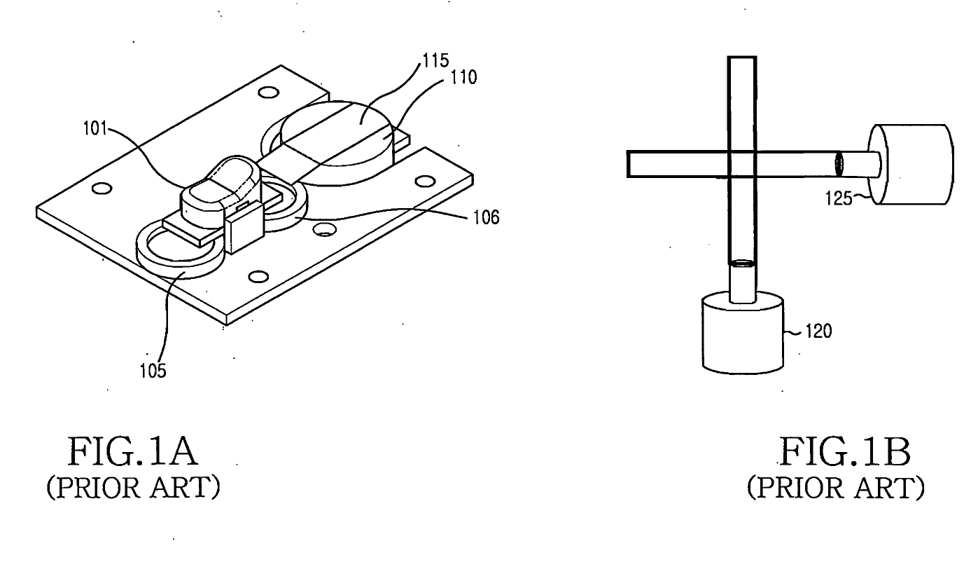

FIG. 2 is a block diagram of a portable terminal having a haptic support apparatus, according to the present invention;

FIG. 3 is a diagram showing a haptic support apparatus operating in a reactivity mode, according to the present invention;

FIG. 4 is a diagram showing a haptic support apparatus operating in vibration mode, according to the present invention;

FIG. 5 is a flowchart showing the operating process of a portable terminal having a haptic support apparatus, according to the present invention; and

FIG. 6 is perspective view of a portable terminal having a haptic support apparatus according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Described hereinafter are an apparatus and method for providing haptic support in a portable terminal according to the present invention. In order to describe the apparatus and method for providing haptic support, a description of the functions required in a portable terminal will first be given, followed by a description of an apparatus capable of providing haptic support while occupying a small installation space.

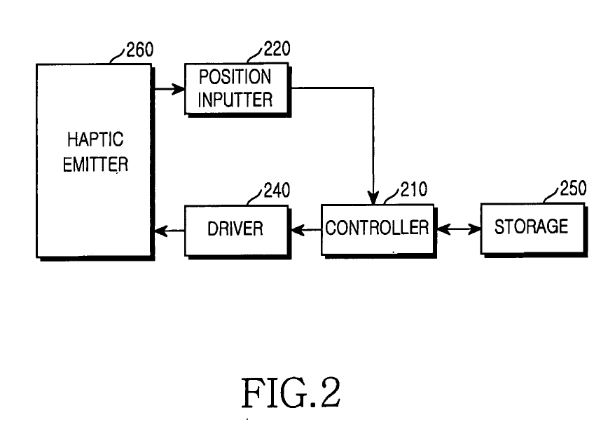

FIG. 2 is a block diagram of a portable terminal having a haptic support apparatus, according to the present invention.

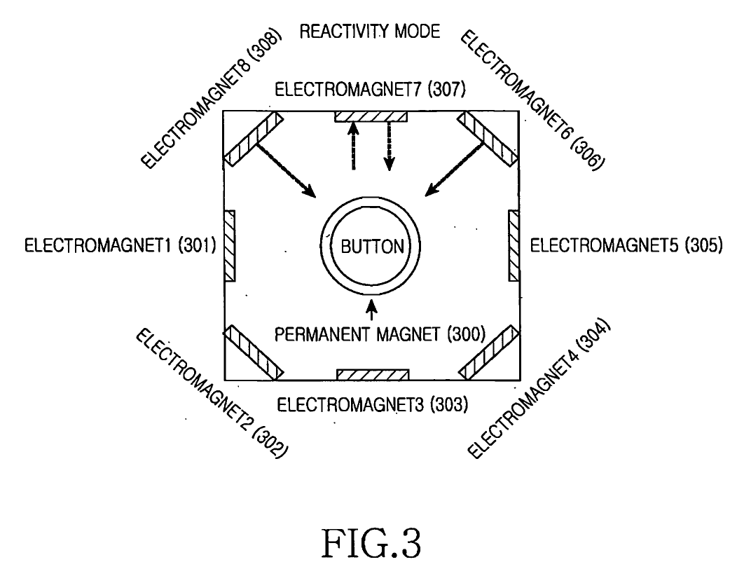

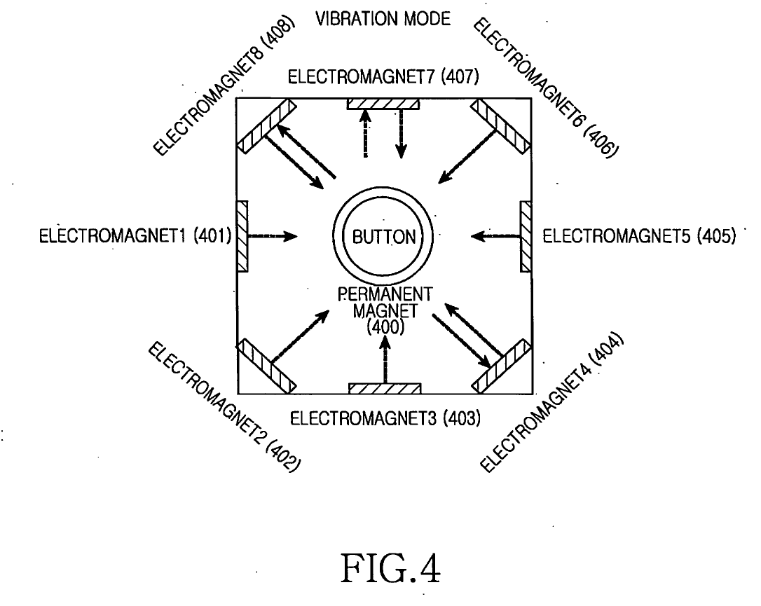

Referring to FIG. 2, a haptic emitter 260 provides a position change to a position inputter 220, according to a user's button inputs, and a control signal prompts an electromagnet to create an electromagnetic field and use the reactivity of permanent magnets for haptic emission. The haptic emitter 260 operates in vibration mode or reactivity mode, according to the type of control signal. The inner structure and detailed operation of the haptic emitter 260 will be described with reference to FIGS. 3 and 4 below.

When it is sensed that the position inputter 220 has changed position, an interrupt (signal) is issued from the haptic emitter 260 according to the position change and the degree of position change, and is provided to the controller 210 along with the position change data through the position inputter 220.

When the controller 210 receives the interrupt from the position inputter 220, it determines whether to provide reactivity or vibration. The determining of whether to implement reactivity or vibration mode is based on the operating program in the controller 210. For example, when a game program is running in the controller 210 and the interrupt is issued, the game program first determines, for example, whether a certain character in the game bumps into a wall and vibrations should be issued as a result, or whether the character is moving in mud so that another appropriate haptic response should be issued in the direction of the character's movement. The controller 210 provides a control signal to the driver 240 for driving the haptic emitter 260 according to the determined results.

When the driver 240 receives a drive signal and control data (direction of force exerted, duration of exerted force, etc.) from the controller 210, the haptic emitter 260 is driven by the control data.

The storage 250 stores data needed to run a game program or other specific program driven in the controller 210.

Thus far, the supporting structure for driving the haptic emitter 260 has been described. The structure and operating process of the haptic emitter 260 will now be described in detail, with reference to the diagram of FIG. 2, which shows a haptic support apparatus operating in reactivity mode, according to the present invention.

Referring to FIG. 3, the haptic support apparatus includes a permanent magnet 300 attached to a button and electromagnets 301-308 for providing reactivity against the permanent magnet 300.

When control data from the controller 210 is input to the driver 240 of the haptic support apparatus, the driver 240 supplies a current to select at least one of electromagnet 301-308 to provide reactivity, based on the control data.

For example, when the button is pushed in an upward direction, the closest electromagnet 307 and neighboring two electromagnets 306 and 308 are supplied with current to form a magnetic field that provides reactivity opposite to an upward direction.

FIG. 4 is a diagram showing a haptic support apparatus operating in vibration mode, according to the present invention.

Referring to FIG. 4, the haptic support apparatus includes a permanent magnet 400 attached to a button and electromagnets 401-408 for providing reactivity to the permanent magnet 400.

When control data from the controller 210 is input to the driver 240 of the haptic support apparatus, the driver 240 supplies a current to select at least one of electromagnet 401-408 to provide reactivity, based on the control data. The permanent magnet 400 and the electromagnets 401-408 are the same as the permanent magnet 300 and electromagnets 301-308 in FIG. 3.

To provide vibration, the operating principle of the haptic support apparatus is as follows. The plurality of electromagnets 401-408 are controlled in sequence to control reactivity against the permanent magnet 400 and allow vibration of the button in any direction within 360°.

For example, when the button is pushed in an upper left direction, the controller 210 first gradually forms an electromagnetic field at the closest electromagnet 408 and the two neighboring electromagnets 401 and 407 so that the button is pushed in the opposite direction—i.e.—the lower right direction. When the permanent magnet returns to the middle, the two electromagnets 402 and 406 on either side form magnetic fields that are gradually increased. In this instance, the magnetic fields of the first three initially magnetized electromagnets 408, 401, and 407 are maximized. When the button passes the center point and proceeds toward the lower right side opposite the upper left side, the magnetic fields of the initial three electromagnets 408, 401, and 407 are turned off.

Then, magnetic fields are gradually formed at the opposite electromagnet 404 on the lower right side and the neighboring electromagnets 403 and 405, so that the button is pushed in an upper left direction (opposite to the lower right direction).

Specifically, when the button nears a certain lateral extremity, magnetic fields of the electromagnets at that extremity are activated to push the button in the opposite direction, whereupon magnetic fields of electromagnets at the opposite extremity are created to push the button back once again, thereby providing resistance to the button to cause vibration thereof.

The operation of the haptic support apparatus in reactivity mode shown in FIG. 3 and vibration mode shown in FIG. 4 is as follows.

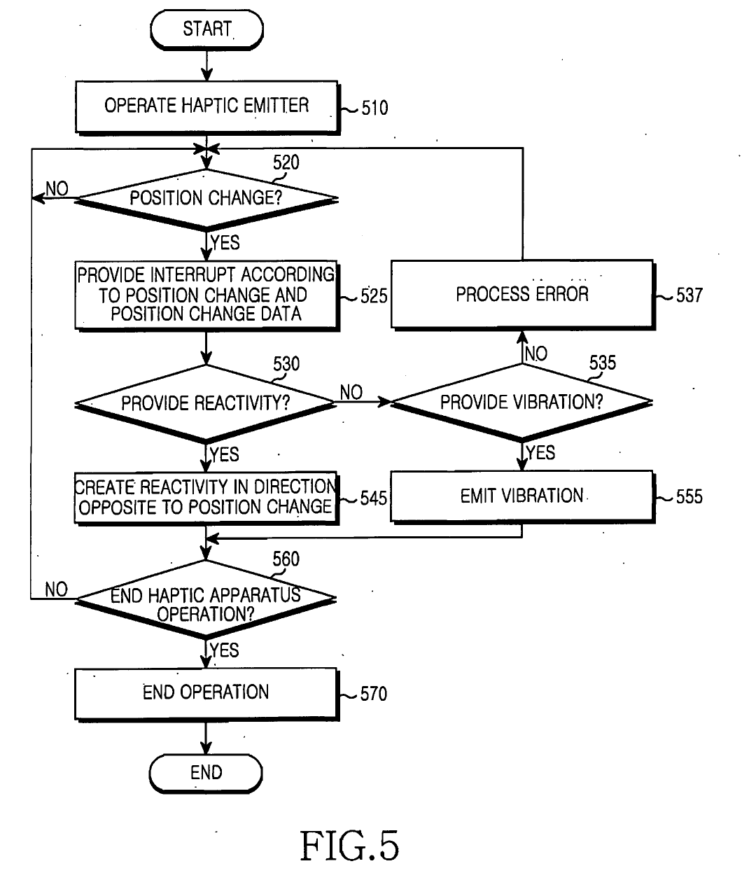

FIG. 5 is a flowchart showing the operating process of a portable terminal having a haptic support apparatus, according to the present invention. It is assumed that the controller 210 is running a program taken from the storage 250.

In accordance with a user's selection or an initial setting, the operation of the haptic support apparatus is begun in step 510.

Then, when the position inputter 220 detects a change in the position of the button through the haptic emitter 260 in step 520, upon the user's manipulation of the button, step 525 is performed, in which an interrupt for signaling the position change of the button and the position change data is provided to the controller 210.

When the program of the controller 210 receives the interrupt and the position change data, the controller determines whether to operate in the reactivity mode in step 530.

If it is determined in step 530 to operate in the reactivity mode, the controller 210 performs step 545, in which it uses the position change data to create reactivity in the direction opposite to the key movement direction. The reactivity is formed by the controller 210 providing data to the driver 240 about an electromagnet and the amount of current to be supplied for creating a magnetic field, upon receipt of which the driver 240 supplies the appropriate currents to the appropriate electromagnets according to the data, forming a magnetic field.

Then, the controller 210 performs step 560, in which it detects if there was a user-input command to end the currently running program, or a similar command to end the operation of the haptic support apparatus.

If it is detected in step 560 that there was a command entered to end the operation of the haptic support apparatus, the operation of the haptic support apparatus is ended in step 570.

If it is detected in step 560 that a command to end the operation of the haptic support apparatus was not entered, step 520 and the subsequent steps are performed.

If it is determined in step 530 not to operate in the reactivity mode, the controller 210 performs step 535, where it determines if operation in the vibration mode should be performed.

If it is determined in step 535 that operation in the vibration mode should be performed, the controller 210 operates the haptic support apparatus in the vibration mode in step 555. To emit vibrations, the controller 210 provides data to the driver 240 about an electromagnet and the amount of current to be supplied for creating a magnetic field, upon receipt of which the driver 240 supplies the appropriate currents to the appropriate electromagnets according to the data, forming a magnetic field. Then, step 560 and the further steps are performed.

If it is determined in step 535 not to operate in vibration mode, it is because of an occurrence of an error. Here, the controller 210 performs step 537, where the error is processed (for example, an error message is displayed or the error is ignored), and step 520 and the subsequent steps are performed.

To summarize, according to a position change of the button, the haptic support apparatus provides reactivity or vibration according to the program being run by the controller 210. This operation continues until the program is ended or the user enters a command to end the operation of the haptic support apparatus.

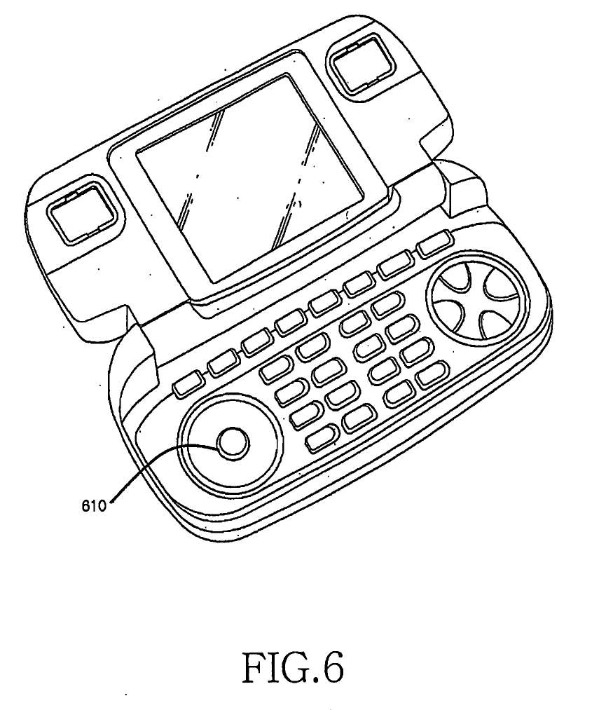

FIG. 6 is perspective view of a portable terminal having a haptic support apparatus according to the present invention.

FIG. 6 shows an example of a portable terminal with a built-in haptic support apparatus. The haptic support apparatus has a predetermined button 610 with electromagnets below it that provide reactivity or vibration through magnetic fields controlled by the controller 210, when a user manipulates the button 610.

The present invention employs a permanent magnet and electromagnets to create magnetic fields that provide reactivity, so that when a user manipulates and changes the position of a button, the reactivity that opposes the change in position, or vibration, can be provided while consuming minimal power and taking up minimal installation space, to provide an efficient apparatus.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for haptic support in a portable terminal, comprising:
a haptic emitter for providing indication of a position change according to a manipulation of a button by a user, and receiving control data and emitting one of a vibration and a reactivity opposite a predetermined direction;
a position inputter for providing data including the position change;
a controller for receiving the data including the position change from the position inputter, and providing a control signal according to settings of a pre-run program; and
a driver for receiving the control signal from the controller, and driving the haptic emitter.

2. The apparatus of claim 1, further comprising a storage for storing one of the program or data required to run the program.

3. The apparatus of claim 1, wherein the haptic emitter comprises:
a permanent magnet connected to and enveloping the button manipulated by the user and disposed within the portable terminal; and
a plurality of electromagnets disposed around the permanent magnet.

4. The apparatus of claim 3, wherein the driver receives the control signal from the controller, and provides a current to at least one of the plurality of electromagnets.

5. The apparatus of claim 4, wherein the haptic emitter forms a magnetic field at the at least one of the plurality of electromagnets through the provided current, for emitting the reactivity opposite the predetermined direction using a magnetic resistance between the at least one of the plurality of electromagnets and the permanent magnet.

6. The apparatus of claim 4, wherein the haptic emitter forms a first magnetic field at the at least one of the plurality of electromagnets through the provided current, for emitting the reactivity opposite the predetermined direction using magnetic resistance between the at least one of the plurality of electromagnets and the permanent magnet, and forms a second magnetic field for emitting a reactivity in the predetermined direction after the button is moved by the reactivity of the first magnetic field.

7. The apparatus of claim 1, wherein the position inputter detects the position change from the haptic emitter, and provides the controller with an interrupt according to the position change and a degree of position change.

8. An apparatus for haptic emitting in a portable terminal, comprising:
a permanent magnet connected to and enveloping a button manipulated by a user and disposed within the portable terminal; and
at least one electromagnet disposed around the permanent magnet.

9. The apparatus of claim 8, wherein the apparatus forms a magnetic field at the at least one electromagnet through a supplied current, and emits a reactivity opposite a predetermined direction using a magnetic resistance between the at least one electromagnet and the permanent magnet.

10. The apparatus of claim 8, wherein the apparatus forms a first magnetic field at the at least one electromagnet through a supplied current, emits a reactivity opposite a predetermined direction using a magnetic resistance between the at least one electromagnet and the permanent magnet, and forms a second magnetic field for emitting a reactivity in the predetermined direction to generate vibration after the button is moved by the reactivity of the first magnetic field.

11. A method for haptic support in a portable terminal, comprising the steps of:
providing data including position change data according to a manipulation of a button by a user;
using the provided data for determining a type of haptic emission to emit;
providing a control signal for emitting the type of haptic emission determined to be emitted; and
emitting the type of haptic emission determined to be emitted through the control signal.

12. The method of claim 11, wherein the provided data includes an interrupt according to the position change data and a degree of position change.

13. The method of claim 11, wherein determining of the type of haptic emission to emit determines whether to emit vibrations or reactivity, according to a setting of a running program.

14. The method of claim 11, wherein the button includes a permanent magnet enveloping a portion thereof and disposed within the portable terminal, and the permanent magnet is surrounded by a plurality of electromagnets.

15. The method of claim 14, wherein the emitting of the type of haptic emission determined to be emitted through the control signal comprises sending a current to at least one of the plurality of electromagnets for forming a magnetic field, and using a repelling force of the permanent magnet to provide a reactivity in a direction opposite to a direction of the manipulation of the button by the user.

16. The method of claim 14, wherein the emitting of the type of haptic emission determined to be emitted through the control signal comprises sending a current to at least one of the plurality of electromagnets for forming a first magnetic field, using a repelling force of the permanent magnet to provide a reactivity in a direction opposite to a direction of the manipulation of the button by the user, and forming a second magnetic field for emitting a reactivity in the direction of the manipulation to generate vibration after the button is moved by the first magnetic field.

17. A portable terminal for haptic support comprising:
a position inputter for providing data including the position change of a haptic emitter;
a controller for receiving the data including the position change from the position inputter, and providing a control signal;
a driver for receiving the control signal from the controller, and driving the haptic emitter; and
the haptic emitter for emitting a vibration or a reactivity.

18. The portable terminal of claim 17, wherein the haptic emitter comprises:
a permanent magnet connected to and enveloping the button manipulated by the user and disposed within the portable terminal; and
a plurality of electromagnets disposed around the permanent magnet.

19. The portable terminal of claim 18, wherein the driver receives the control signal from the controller, and provides a current to at least one of the plurality of electromagnets.
